(19) United States
(12) Patent Application Publication
(10) Pub. No.: US 2025/0340063 A1
(43) Pub. Date: Nov. 6, 2025

(54) INK STORAGE CONTAINER AND INK EJECTION APPARATUS

(71) Applicant: CANON KABUSHIKI KAISHA, Tokyo (JP)

(72) Inventors: SATORU TAKAHASHI, Kanagawa (JP); MITSURU CHIDA, Kanagawa (JP); JUNICHIRO IRI, Kanagawa (JP); DAISUKE NAKAGAWA, Kanagawa (JP)

(21) Appl. No.: 19/193,632

(22) Filed: Apr. 29, 2025

(30) Foreign Application Priority Data
May 1, 2024 (JP) 2024-074338

(51) Int. Cl. B41J 2/175

(52) U.S. Cl. CPC B41J 2/17546; B41J 2/17513; B41J 2/17553; B41J 2002/17516

(57) ABSTRACT

An ink storage container attachable to and detachable from an apparatus main body of an ink ejection apparatus includes: a storage portion that stores ink, the storage portion including an ink discharge portion capable of discharging the stored ink to an outside of the storage portion; and an information member that stores information capable of being read from the outside. In the ink storage container, the information member is provided in a flexible part of the storage portion and is configured to enable the information to be read in a non-contact manner from the outside and the information member is configured such that the information readable by an optical reading device or an RFID-based reading device. The technology described in this specification have the potential to contribute to the achievement of a sustainable society, such as a decarbonized society/circular society.

### BACKGROUND OF THE INVENTION

### Field of the Invention

The present invention relates to an ink storage container used in an ink ejection apparatus.

### Description of the Related Art

In recording apparatuses serving as ink ejection apparatuses (liquid ejection apparatuses) that eject ink onto recording media as recording liquid to perform recording, it is conventionally known that consumed ink is replenished using ink tanks serving as ink storage containers (liquid storage containers) that are detachable from the apparatus bodies. In this configuration, in order to reduce the frequency of ink tank replacements, it is known that the liquid storage portions are configured as bags made of flexible films, such as polyethylene films, so as to facilitate handling while increasing the capacities of the ink tanks (Japanese Patent Application Laid-open No. 2018-65374).

### SUMMARY OF THE INVENTION

Ink tanks may be equipped with, for example, storage elements or the like serving as information members that store information related to stored ink. The information stored in the storage elements is read by reading portions provided in the apparatus main bodies. However, in order to establish reliable connections between the electrical contacts of the storage elements and the electrical contacts of the apparatus main bodies, the storage elements are provided in housing portions of the ink tanks that maintain a constant shape. In Japanese Patent Application Laid-open No. 2018-65374, the parts that position the electrical contacts of storage elements in ink tanks are configured using a material primarily made of plastic.

Here, as a social demand in recent years, technical developments that may contribute to the achievement of a sustainable society, such as a decarbonized society/circular society, have been sought. It is required that the use of the plastic material as described above be minimized in order to realize the 3Rs (Reduce, Reuse, Recycle), which have been particularly advocated in recent years.

An object of the present invention is to provide a technology that may contribute to the realization of the 3Rs in an ink storage container used in an ink ejection apparatus.

In order to achieve the above object, the present invention provides an ink storage container attachable to and detachable from an apparatus main body of an ink ejection apparatus, including:
a storage portion that stores ink, the storage portion including an ink discharge portion capable of discharging the stored ink to an outside of the storage portion; and
an information member that stores information readable from the outside, wherein
the information member is provided in a flexible part of the storage portion and is configured to enable the information to be read in a non-contact manner from the outside, and
wherein the information member is configured such that the information readable by an optical reading device or an RFID-based reading device.

In order to achieve the above object, the present invention provides an ink ejection apparatus including:
the ink storage container of the present invention;
a container storage portion that stores the ink storage container;
a reading portion that reads information from the information member;
an ink feeding portion connected to the ink discharge portion; and
an ejection portion that ejects ink fed from the ink feeding portion.

According to the present invention, it is possible to contribute to the realization of the 3Rs in an ink storage container used in an ink ejection apparatus.

Further features of the present invention will become apparent from the following description of exemplary embodiments with reference to the attached drawings.

### BRIEF DESCRIPTION OF THE DRAWINGS

FIG. 1 is a perspective view showing the internal configuration of the essential part of a recording apparatus in a first embodiment;

FIG. 2 is a perspective view showing the configuration of a liquid storage portion in FIG. 1;

FIG. 3 is a perspective view showing the configuration of a liquid storage container in the first embodiment;

FIGS. 4A and 4B are side views of the liquid storage container in the first embodiment;

FIG. 5 is a perspective view showing the configuration of a liquid storage container in a second embodiment;

FIGS. 6A and 6B are side views of the liquid storage container in the second embodiment;

FIG. 7 is a perspective view showing the configuration of a liquid storage container in a third embodiment;

FIG. 8 is a perspective view showing the configuration of the liquid storage container in the third embodiment;

FIGS. 9A and 9B are side views of the liquid storage container in the third embodiment;

FIG. 10 is a perspective view showing the configuration of a liquid storage container in a fourth embodiment; and

FIG. 11 is a cross-sectional view taken along line X-X in FIG. 10.

### DESCRIPTION OF THE EMBODIMENTS

Hereinafter, with reference to the drawings, embodiments for carrying out the present invention will be described in detail by way of examples. However, the dimensions, materials, shapes, relative arrangements, and the like of the components described in the embodiments may be appropriately modified according to the configurations or various conditions of the apparatus to which the invention is applied. In other words, the scope of the invention is not intended to be limited to the following embodiments.

Furthermore, each embodiment described below includes a plurality of features. However, all of these features are not necessarily essential for the invention, and they may be arbitrarily combined. Moreover, in the attached drawings, configurations that are the same or similar between the embodiments are denoted by the same reference numerals, and duplicate descriptions are omitted.

### First Embodiment

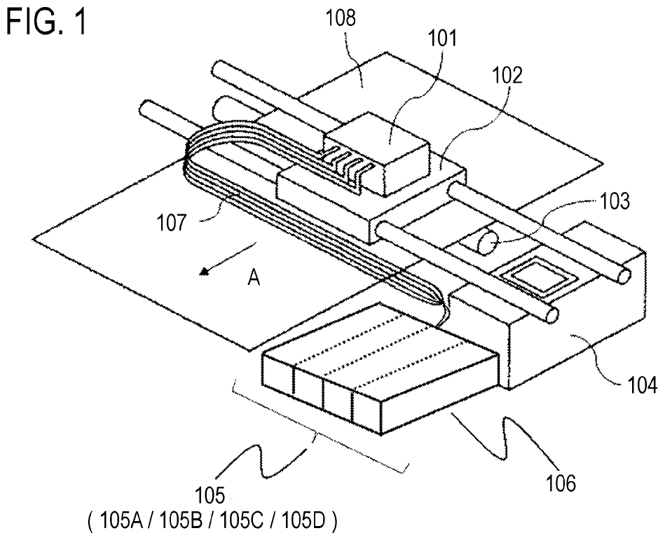

FIG. 1 is a perspective view showing the schematic configuration of a recording apparatus serving as a liquid ejection apparatus according to a first embodiment of the present invention. The recording apparatus shown in FIG. 1 repeatedly performs the reciprocating movement (main scanning) of a recording head 101 and the conveyance (sub-scanning) of a recording sheet 108, which serves as a recording medium, for each specified pitch. In synchronization with these movements, the recording apparatus selectively ejects a plurality of colors of liquids from the recording head 101 and lands them on the recording sheet 108, which serves as the recording medium, thereby forming characters, symbols, images, and the like. Note that any recording medium may be used as long as it enables image formation through the landing of liquid droplets thereon. For example, various materials and forms, such as papers, fabrics, optical-disk label surfaces, plastic sheets, OHP sheets, and envelopes, may be used as recording media. Note that the liquid stored in a liquid storage container to which the present invention is applicable is typically ink. However, the liquid is not limited to this and may also include a reaction liquid or pretreatment liquid that is replenished into the liquid ejection apparatus.

As shown in FIG. 1, the recording head 101 is slidably supported by two guide rails and is detachably mounted on a carriage 102 that reciprocates in a straight line along the guide rails by a drive unit such as a motor (not shown). The recording sheet 108 that receives the liquid ejected from the liquid ejection portion of the recording head 101 is opposed to the liquid ejection surface of the recording head 101 and is conveyed in a direction crossing the movement direction of the carriage 102 by a conveyance roller 103 serving as a conveyance member. The recording head 101 has a plurality of nozzle rows as liquid ejection portions, each ejecting a liquid of a different color.

A plurality of independent liquid storage portions 105, each having a liquid feeding port 109, are detachably loaded into a liquid feeding unit 106 corresponding to the color of a liquid ejected from the recording head 101. The liquid feeding unit 106 and the recording head 101 are connected to each other via a plurality of liquid feeding tubes 107, each corresponding to the color of a liquid. By loading the liquid storage portions 105 into the liquid feeding unit 106, it becomes possible to independently feed the liquid of each color stored in the liquid storage portions 105 to each nozzle row of the recording head 101.

In a non-recording region that is within the reciprocating range of the recording head 101 and outside the passing range of the recording sheet 108, a recovery unit 104 is arranged to face the liquid ejection surface of the recording head 101. The recovery unit 104 has a cap portion used to cap the liquid ejection surface of the recording head 101, a suction mechanism used to forcibly suck the liquid with the liquid ejection surface capped, a cleaning blade used to wipe off stains from the liquid ejection surface, and the like. The above-described suction operation is performed by the recovery unit 104 prior to the recording operation of the recording apparatus. As a result, even when the recording apparatus operates after being unused for a long period, the recovery process performed by the recovery unit 104 enables the removal of residual air bubbles inside the ejection portions or thickened liquid near the ejection ports of the recording head 101. Thus, the ejection characteristics of the recording head 101 are maintained.

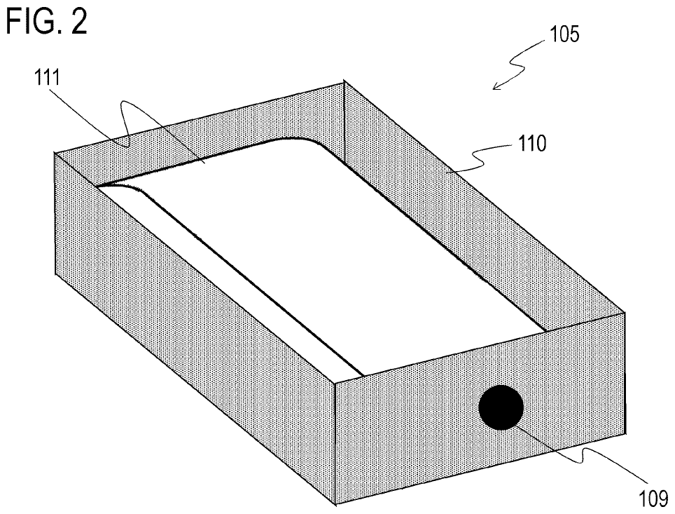

FIG. 2 is a perspective view schematically showing the interior of the liquid storage portion 105 that is installed into the liquid feeding unit 106 of the recording apparatus in FIG. 1.

The liquid storage portion 105 is composed of a tray 110 that serves as a container storage portion with the liquid feeding port 109 serving as a liquid feeding portion, and a liquid storage container 111 that is made of a flexible film or the like and stores a liquid. The liquid storage container 111 is configured to be attachable to and detachable from the tray 110 that is a configuration of the apparatus main body of the recording apparatus. When the liquid storage portion 105 is installed into the liquid feeding unit 106 of the recording apparatus, the liquid storage container 111 is first installed on the bottom surface of the tray 110 such that the liquid feeding port 109 of the tray 110 is at the same height as the liquid feeding port of the liquid storage container 111. Upon installation of the liquid storage portion 105, in which the liquid storage container 111 is placed in the tray 110, into the liquid feeding unit 106, the liquid inside the liquid storage container 111 is fed to the recording head 101 via the liquid feeding tubes 107 provided in the recording apparatus. The liquid stored in the liquid storage container 111 is sucked from the liquid storage container 111 through the liquid feeding port 109 by pressure variations generated by a pressure generation portion, such as a pump (not shown), and is delivered to the recording head 101 via the liquid feeding tubes 107.

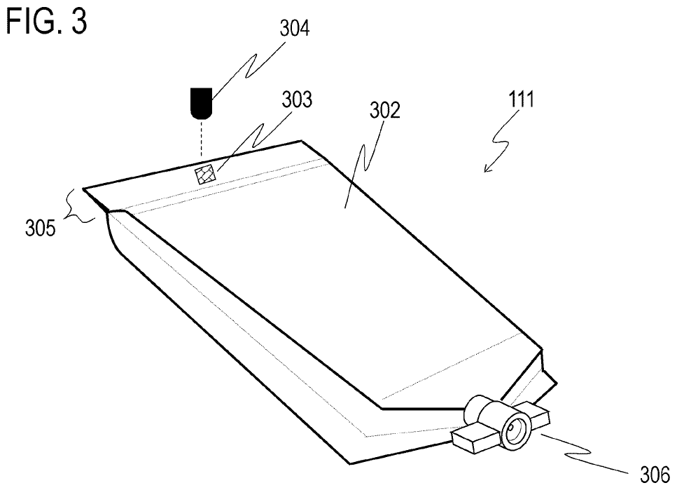

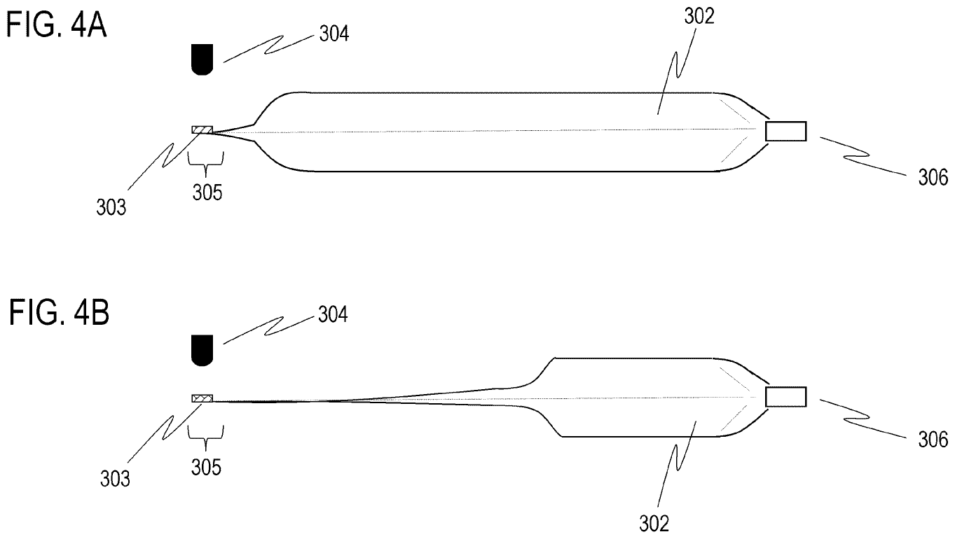

FIG. 3 shows an example of the structure of the liquid storage container 111 and an example of the arrangement of an information member in the first embodiment of the present invention. FIGS. 4A and 4B respectively show a side view of the liquid storage container 111 and a side view of the liquid storage container 111 when a liquid inside the liquid storage portion 302 is consumed in the first embodiment of the present invention.

The liquid storage container 111 includes the liquid storage portion 302 that stores a liquid (typically ink), and a recording medium 303 that serves as an information member storing information readable from the outside. The liquid storage portion 302 includes a liquid discharge portion 306 that is capable of discharging the stored liquid to the outside of the liquid storage portion 302. The liquid storage portion 302 is configured to be generally flexible as a whole, and the recording medium 303 is provided in the flexible part of the liquid storage portion 302.

The liquid storage portion 302 is composed of a part (first part) made of a material (first material) that is deformable in response to pressure from the stored liquid, and a part (second part) made of a material (second material) that is capable of maintaining a constant shape against the pressure from the stored liquid.

The material (second material) of the latter part (second part) is, for example, plastic, and the liquid discharge portion 306 is provided in this part. This part (second part) is a part that positions the liquid storage container 111 with respect to the tray 110, and its constant shape is maintained even when the pressure from the stored liquid varies, thereby ensuring a stable connection between the liquid discharge portion 306 and the liquid feeding port 109. The latter part (second part) is a very small part of the entire liquid storage portion 302. It can be said that only the liquid discharge portion 306 in the liquid storage portion 302 is made of the material (second material) that constitutes the latter part. Alternatively, it can also be said that only the part of the liquid storage container 111 that requires a certain degree of rigidity from the viewpoint of positioning with respect to the tray 110 or providing the liquid discharge portion 306 is made of the latter part (second part). In other words, it can also be said that only the part of the liquid storage container 111 that requires high rigidity is made of the material (second material) with high rigidity, while the remaining large part of the liquid storage container 111 that does not require high rigidity is made of the material (first material) with lower rigidity than the other material.

The flexible part (first part) of the liquid storage portion 302 serves as the first material and is made of a material with flexibility, gas barrier properties, and liquid non-permeability. For example, the part may be configured using a film-shaped member made of a material such as polyethylene terephthalate (PET), nylon, or polyethylene. Furthermore, the part may also be composed of stacked film-shaped members made of the above-described materials. In this case, for example, the outer layer may be formed of a PET or nylon film with excellent shock resistance, while the inner layer may be formed of a polyethylene film with excellent ink resistance. Moreover, a layer with aluminum or the like deposited thereon may also be added to the stacked structure.

The recording medium 303, on which information about the stored liquid is recorded, is attached to the liquid storage portion 302. The recording apparatus is provided with a reading mechanism 304 that serves as a reading portion capable of reading information from the recording medium 303 in a non-contact manner. The control portion of the recording apparatus is capable of determining, for example, whether the installed liquid storage container 111 is valid (i.e., whether it has been incorrectly installed), using the liquid information read from the recording medium 303 by the reading mechanism 304. Alternatively, the control portion may be configured to control the recording operation on the basis of the read information about the type of the liquid.

The reading mechanism 304 in the first embodiment is provided vertically above the recording medium 303 of the liquid storage container 111 installed in the recording apparatus, and may be configured to have a mechanism that projects light, such as illumination, vertically downward onto the recording medium 303. Furthermore, the reading mechanism 304 may be an optical reading device that is equipped with an optical sensor, such as a CCD sensor, to read the information obtained when the projected light is reflected by the recording medium 303.

The recording medium 303 in the first embodiment may be an optical identifier, such as a one-dimensional barcode or a two-dimensional barcode. In the liquid storage portion 302, the recording medium 303 is preferably provided on the surface of the liquid storage portion 302 at a position that serves as the upper vertical surface (opposite to the side facing the bottom surface of the tray 110) when attached to the tray 110.

Moreover, in this embodiment, the recording medium 303 is provided at a pressure portion 305 that serves as a bonded portion (welded portion) formed by bonding together a plurality of film-shaped members to form the liquid storage portion 302. The pressure portion 305 is a part where deformation is particularly unlikely to occur in a part made of a flexible material. By arranging the recording medium 303 at this position, the position of the recording medium 303 in the liquid storage portion 302 becomes stabilized. In other words, it becomes unnecessary to use a plastic member, as in the conventional art, for securing the position of the recording medium 303.

Furthermore, in the longitudinal direction of the liquid storage portion 302 that has a substantially rectangular shape in plan view, the pressure portion 305 where the recording medium 303 is arranged is provided at the other end side relative to one end side where the liquid discharge portion 306 is arranged. The liquid storage portion 302 includes a pair of ends (first ends) that face each other in the longitudinal direction (first direction), and a pair of ends (second ends) that face each other in a short direction (second direction) orthogonal to the longitudinal direction. The stored liquid is discharged from the liquid discharge portion 306 in a direction along the longitudinal direction. The pressure portion 305 is formed at the end of the liquid storage portion 302 opposite to the end where the liquid discharge portion 306 is provided, and has a width shorter than the longitudinal width. Even when the amount of the liquid stored in the liquid storage portion 302 varies, the position of the pressure portion 305 does not significantly fluctuate. Accordingly, even if the liquid storage portion 302 deforms as the liquid in the liquid storage container 111 is consumed, the recording medium 303 is able to remain parallel to the reading mechanism 304, enabling stable reading.

### Second Embodiment

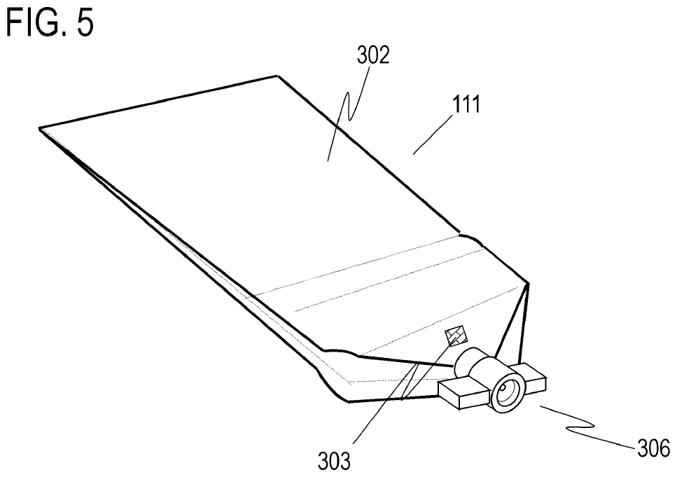

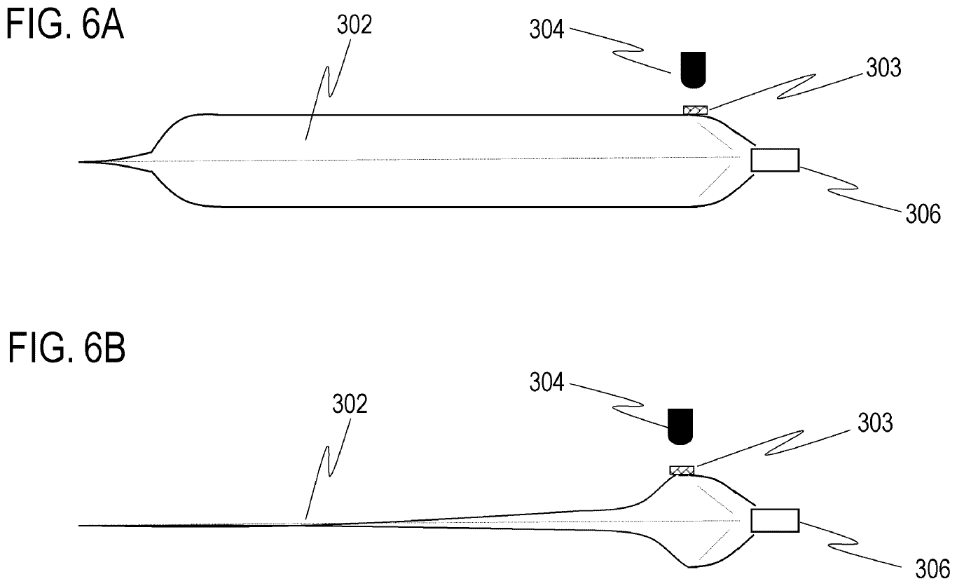

FIG. 5 shows an example of the structure of a liquid storage container and an example of the arrangement of an information member in a second embodiment of the present invention. FIGS. 6A and 6B respectively show a side view of a liquid storage container 111 and a side view of the liquid storage container 111 when a liquid inside a liquid storage portion 302 is consumed in the second embodiment of the present invention.

Here, in the second embodiment, the configurations that differ from those of the first embodiment will be primarily described, while the descriptions of the configurations that are common to the first embodiment will be appropriately omitted. Matters not particularly described in the second embodiment are common to the first embodiment.

Like in the first embodiment, the liquid storage portion 302 of the liquid storage container 111 in the second embodiment is also made of a material with flexibility, gas barrier properties, and liquid non-permeability. For example, the liquid storage portion 302 may be configured using a film-shaped member made of a material such as polyethylene terephthalate (PET), nylon, or polyethylene. Furthermore, the liquid storage portion 302 may also be composed of stacked film-shaped members made of the above-described materials. In this case, for example, the outer layer may be formed of a PET or nylon film with excellent shock resistance, while the inner layer may be formed of a polyethylene film with excellent ink resistance. Moreover, a layer with aluminum or the like deposited thereon may also be added to the stacked structure.

In the second embodiment as well, a reading mechanism 304 is provided vertically above a recording medium 303 of the liquid storage container 111. In addition, the reading mechanism 304 may have a mechanism that projects light, such as illumination, vertically downward onto the recording medium 303 and may be equipped with an optical sensor that detects light reflected from the recording medium 303. Furthermore, in the second embodiment as well, the recording medium 303 is an optical type, such as a one-dimensional barcode or a two-dimensional barcode, and is preferably provided at a position that serves as the upper vertical surface when attached to a recording apparatus.

Furthermore, in the configuration of the liquid storage portion 302 in plan view, the recording medium 303 is preferably provided near a liquid discharge portion 306. More specifically, the recording medium 303 is preferably provided near the connecting portion between a first part with flexibility in the liquid storage portion 302 and a second part where the liquid discharge portion 306 is arranged. In the flexible first part of the liquid storage portion 302, this position does not fluctuate largely even when the amount of a liquid stored in the liquid storage portion 302 varies. By arranging the recording medium 303 at this position, the position of the recording medium 303 in the liquid storage portion 302 becomes stabilized. In other words, it becomes unnecessary to use a plastic member, as in the conventional art, for securing the position of the recording medium 303.

Note that at this arrangement position, the recording medium 303 may have difficulty in remaining parallel to the reading mechanism 304 when the liquid storage portion 302 deforms as the stored liquid is consumed. However, since a change in the distance between the reading mechanism 304 and the recording medium 303 is small, stable reading is expected.

### Third Embodiment

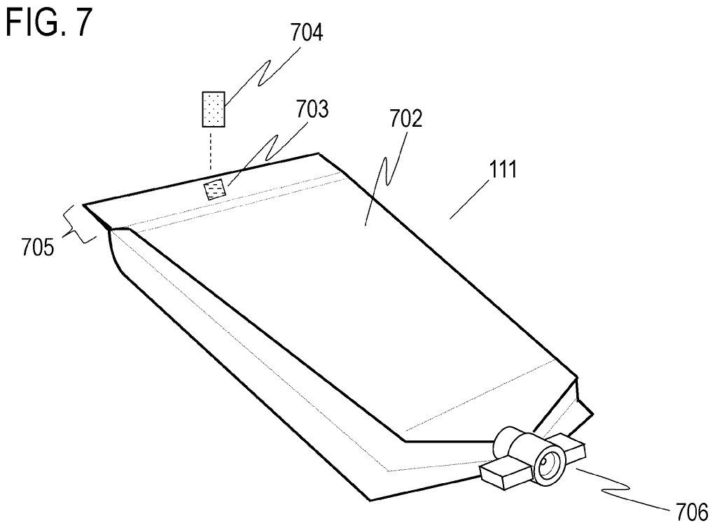

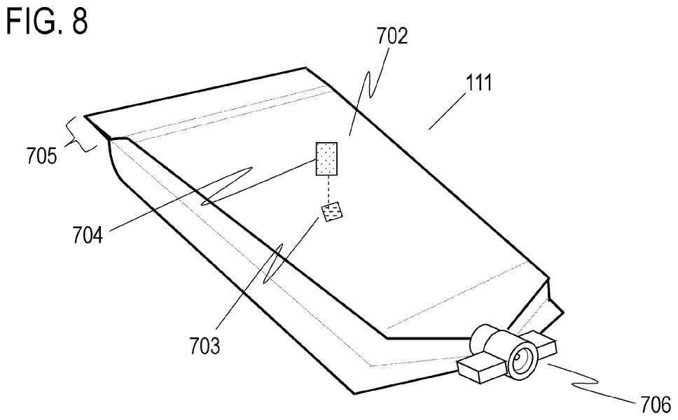

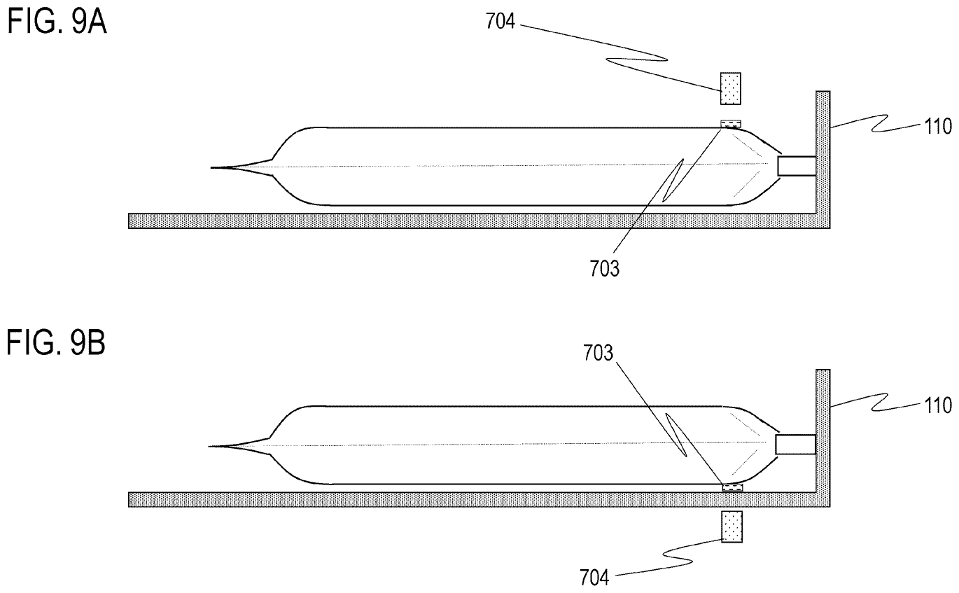

FIGS. 7 and 8 show an example of the structure of a liquid storage container and an example of the arrangement of an information member in a third embodiment of the present invention. FIGS. 9A and 9B respectively show a side view of a liquid storage container 111 where a recording medium 703 serving as an information member is provided on the upper surface and a side view of the liquid storage container 111 where the recording medium 703 is provided on the lower surface in the third embodiment of the present invention.

Here, in the third embodiment, the configurations that differ from those of the first and second embodiments will be primarily described, while the descriptions of the configurations that are common to the first and second embodiments will be appropriately omitted. Matters not particularly described in the third embodiment are common to the first and second embodiments.

Like in the first embodiment, a liquid storage portion 702 in the third embodiment may be made of a material with flexibility, gas barrier properties, and liquid non-permeability, such as polyethylene terephthalate (PET), nylon, or polyethylene. Furthermore, the liquid storage portion 702 may also be composed of stacked films made of the above-described materials. However, when the liquid storage portion 702 is composed of stacked films, it is preferably not subjected to the deposition of a metallic substance such as aluminum.

In the third embodiment, when the liquid storage container 111 is mounted in a recording apparatus and the recording medium 703 is positioned on the upper surface of the liquid storage portion 702, a reading mechanism 704 is provided vertically above the recording medium 703. Furthermore, when the recording medium 703 is positioned on the lower surface of the liquid storage portion 702 (the surface facing the bottom surface of a tray 110), the reading mechanism 704 is preferably provided vertically below the recording medium 703. Furthermore, when the reading mechanism 704 is provided vertically below the recording medium 703, the tray 110 of a liquid feeding unit 106 may also be interposed between the reading mechanism 704 and the recording medium 703.

Furthermore, in this embodiment, the recording medium 703 and the reading mechanism 704 are configured using a reading unit based on a radio frequency identification (RFID) system. In other words, the reading mechanism 704 has a mechanism that applies electromagnetic waves containing an information reading signal, such as RFID-standard electromagnetic waves, to the recording medium 703 and receives a response signal from the recording medium 703. In this embodiment, the recording medium 703 is preferably one that generates a response signal through the application of electromagnetic waves, such as an RFID tag.

Furthermore, in this embodiment, the recording medium 703 is provided at a position on the surface of the liquid storage portion 702, which serves as either the upper vertical surface or the lower vertical surface when attached to a recording apparatus. Note that the recording medium 703 may be provided either at a position on the surface of the liquid storage portion 702 as shown in FIG. 8 or at a position on the surface of a pressure portion 705 as shown in FIG. 7.

According to this embodiment, it becomes unnecessary to use a plastic member for securing the position of the recording medium 703. Furthermore, even when the liquid storage portion 702 deforms as the stored liquid is consumed, stable reading is expected as long as the electromagnetic waves from the reading mechanism 704 reach the recording medium 703.

### Fourth Embodiment

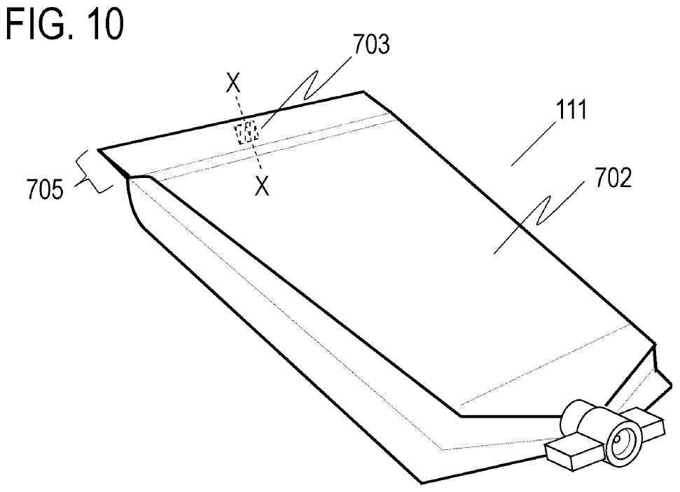

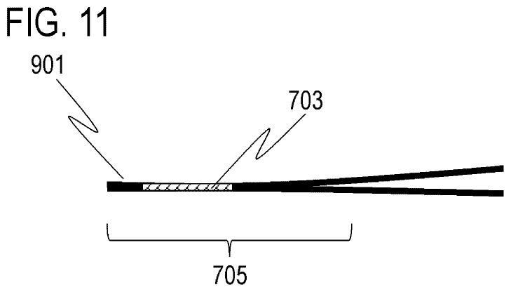

FIG. 10 shows an example of the structure of a liquid storage container and an example of the arrangement of an information member in a fourth embodiment of the present invention. FIG. 11 shows a cross-sectional view taken along line X-X in FIG. 10.

Here, in the fourth embodiment, the configurations that differ from those of the first to third embodiments will be primarily described, while the descriptions of the configurations that are common to the first to third embodiments will be appropriately omitted. Matters not particularly described in the fourth embodiment are common to the first to third embodiments.

Like in the third embodiment, a liquid storage portion 702 in the fourth embodiment may be made of a material with flexibility, gas barrier properties, and liquid non-permeability, such as polyethylene terephthalate (PET), nylon, or polyethylene. Furthermore, the liquid storage portion 702 may also be composed of stacked films made of the above-described materials. However, when the liquid storage portion 702 is composed of stacked films, it is preferably not subjected to the deposition of a metallic substance such as aluminum.

Like in the third embodiment, when a liquid storage container 111 is mounted in a recording apparatus and a recording medium 703 is positioned on the upper surface of the liquid storage portion 702, a reading mechanism 704 is provided vertically above the recording medium 703 in the fourth embodiment. Furthermore, when the recording medium 703 is positioned on the lower surface of the liquid storage portion 702, the reading mechanism 704 is preferably provided vertically below the recording medium 703.

Furthermore, in this embodiment as well, the reading mechanism 704 has a mechanism that applies electromagnetic waves containing an information reading signal, such as RFID-standard electromagnetic waves, to the recording medium 703 and receives a response signal from the recording medium 703. In this embodiment, the recording medium 703 is preferably one that generates a response signal through the application of electromagnetic waves, such as an RFID tag.

Furthermore, in this embodiment, the recording medium 703 is provided so as to be sandwiched between a plurality of welded films 901 at a pressure portion 705 formed during the creation of the liquid storage portion 702.

According to this embodiment, since a change in the distance between the reading mechanism 704 and the recording medium 703 is small even when the liquid storage portion 702 deforms as the stored liquid is consumed, more stable reading is expected.

According to the fourth embodiment, it becomes unnecessary to use a plastic member for securing the position of the recording medium 703. In addition, it becomes possible to incorporate the recording medium 703 simultaneously with the molding of the liquid storage portion 702, contributing further to a reduction in the amount of materials, such as adhesive, used in the arrangement of the recording medium 703.

As described above, by providing a noncontact-type information reading mechanism in the flexible part of a liquid storage container, the structures of the liquid storage container and the liquid feeding port of an apparatus main body are simplified, enabling cost reduction. Furthermore, by eliminating or significantly downsizing structures primarily made of plastic, it becomes possible to fully meet the growing demand for the 3Rs in recent years. In other words, the technology described in this specification have the potential to contribute to the achievement of a sustainable society, such as a decarbonized society/circular society.

In the above embodiments, the respective configurations may be combined with each other.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074338. filed on May 1, 2024, which is hereby incorporated by reference herein in its entirety.

What is claimed is:

1. An ink storage container attachable to and detachable from an apparatus main body of an ink ejection apparatus, the ink storage container comprising:
a storage portion that stores ink, the storage portion including an ink discharge portion capable of discharging the stored ink to an outside of the storage portion; and
an information member that stores information readable from the outside, wherein
the information member is provided in a flexible part of the storage portion and is configured to enable the information to be read in a non-contact manner from the outside, and
wherein the information member is configured such that the information readable by an optical reading device or an RFID-based reading device.

2. The ink storage container according to claim 1,
wherein the storage portion includes:
a first part made of a first material that is deformable in response to pressure from the stored ink; and
a second part made of a second material that is capable of maintaining a constant shape against the pressure from the stored ink,
wherein the information member is provided in the first part, and
wherein the ink discharge portion is provided in the second part.

3. The ink storage container according to claim 2,
wherein the ink discharge portion is provided at one end side of the storage portion in a longitudinal direction, and
wherein the information member is provided at an other end side of the storage portion in the longitudinal direction.

4. The ink storage container according to claim 2,
wherein the first part is formed by bonding a plurality of film-shaped members together, and
wherein the information member is provided at a bonded portion of the plurality of film-shaped members.

5. The ink storage container according to claim 4, wherein
the information member is provided so as to be sandwiched between the plurality of film-shaped members at the bonded portion.

6. The ink storage container according to claim 2, wherein
the information member is provided on a surface of the first part.

7. The ink storage container according to claim 2,
wherein the ink discharge portion is provided at one end side of the storage portion in a longitudinal direction, and
wherein the information member is provided near the ink discharge portion.

8. The ink storage container according to claim 2, wherein
the second material is plastic.

9. The ink storage container according to claim 2,
wherein the ink storage container is configured to be stored in a container storage portion of the apparatus main body, and
wherein the second part is a part that positions the ink storage container with respect to the container storage portion.

10. The ink storage container according to claim 9, wherein
the information member is provided on an opposite side of the first part to a side facing a bottom surface of the container storage portion.

11. The ink storage container according to claim 9, wherein
the information member is provided on a side of the first part that faces a bottom surface of the container storage portion.

12. The ink storage container according to claim 1, wherein
information stored in the information member is information related to the ink stored in the storage portion.

13. An ink ejection apparatus comprising:
the ink storage container according to claim 1;
a container storage portion that stores the ink storage container;
a reading portion that reads information from the information member;
an ink feeding portion connected to the ink discharge portion; and
an ejection portion that ejects ink fed from the ink feeding portion.
